(19) United States
(12) Patent Application Publication
(10) Pub. No.: US 2018/0092371 A1
(43) Pub. Date: Apr. 5, 2018

(54) PASTEURIZATION FOR SMALL CONTAINERS USING A PHASE CHANGE MATERIAL

(71) Applicants: Micaela Langille Collins, Toronto (CA); Scott Nicholas Genin, Unionville (CA); Jayesh Kumar Srivastava, West Toronto (CA); Yu-Ling Cheng, Toronto (CA)

(72) Inventors: Micaela Langille Collins, Toronto (CA); Scott Nicholas Genin, Unionville (CA); Jayesh Kumar Srivastava, West Toronto (CA); Yu-Ling Cheng, Toronto (CA)

(21) Appl. No.: 15/723,992

(22) Filed: Oct. 3, 2017

Related U.S. Application Data
(60) Provisional application No. 62/403,442, filed on Oct. 3, 2016.

(51) Int. Cl. A23C 3/02; A23C 9/20; A23L 3/10

(52) U.S. Cl. CPC A23C 3/02; A23V 2300/24; A23L 3/10; A23C 9/206

(57) ABSTRACT

A pasteurization device comprising an insulated heating tub, a metal grid heat sink, 69° C. melt-point paraffin wax, wherein the metal grid heat sink and the paraffin wax are combined inside the insulated heating tub; a temperature sensor connected to a microprocessor controlled device, suitable to measure temperature and to generate an alarm, a top plate, and a material suitable to cover the wax; wherein the top plate comprises a plurality of openings corresponding to an opening in the metal grid heat sink of suitable size to accept a baby bottle; wherein the insulated heating tub can be heated to at least 73° C. and wherein the microprocessor controlled device provides an audible tone upon the temperature sensor reading 73° C. for at least 30 seconds.

### CROSS REFERENCE TO RELATED APPLICATIONS

The present application claims the benefit of U.S. provisional patent application No. 62/403,442, filed Oct. 3, 2016, which is incorporated herein by reference in its entirety.

### FIELD OF INVENTION

The present invention is generally related to breast milk pasteurization machines using a phase change material

### BACKGROUND OF INVENTION

Breast milk provides a superior source of infant nutrition. With an unparalleled range of antibodies and nutrients, it is the most complete food source for infants under two years of age. Mothers who can stay with their infants post-partum may breastfeed their infants directly and provide this valuable resource to their infant and through toddler years. However for working mothers, who must be away from their child, it is often incredibly difficult to provide breast milk to their infants, especially where they lack access to refrigeration.

For working mothers who have access to refrigeration, it is a relatively simple process to pump or hand-express milk, and then refrigerate it so that to be bottle-fed to their infants and toddlers at a later point. Milk can also be frozen for later use. However, for those women who lack access to refrigeration, it is nearly impossible to express and store milk for later feeding, as expressed breast milk is only shelf stable at room temperature for a short period of time.

Pasteurization of breast milk is an alternative solution to prolong the shelf life of breast milk in instances where refrigeration is not possible. This is especially true in resource limited settings, where infant nutrition is otherwise extremely limited without access to breast milk. Conventional pasteurization machines rely on water to transfer heat. When a bottle containing unpasteurized milk (or other liquid) is placed in a device, the surrounding water drops in temperature and reduces the temperature gradient. Ultimately, the milk is pasteurized by being maintained at about 60° C. for 30 minutes, before chilling for later use (Holder Pasteurization—also known as low temperature long time (LTLT)). Alternatively, high temperature short time (HTST) pasteurization, which heats milk to 72.5° C. for 15 seconds, may be used. Traditionally, both these methods of pasteurization are large scale, prohibitively expensive, and require large quantities of water. However, their benefits, including maintaining the stability of the liquids being pasteurized are highly desired.

### SUMMARY OF INVENTION

A device suitable for HTST pasteurizing expressed milk uses a phase change material with a greater capacity to store latent heat than water to provide temperature control. Paraffin wax is utilized as the phase change material, where the wax has a melt-point of 69° C. and can be suitably heated to and maintained at 73° C. Unlike water, the paraffin wax does not evaporate, prevents microbial growth, and so does not need to be replaced between pasteurization cycles. The paraffin wax also acts as a heat sink and minimizes the water used for the pasteurization process.

In a preferred embodiment, the device comprises an insulated heating element, a reference bottle filled with water, a temperature sensor, an alarm programmed to sound 30 seconds after the temperature sensor reads a result of 73° C., 69° C. melt-point paraffin wax in which a copper wire is placed to aid in heat distribution, a plastic top plate, and a set of bags suspended from the top plate and positioned so that one side of the bag is in contact with the paraffin wax, and the other side open to accept a bottle placed therein.

A pasteurization device comprising an insulated heating element, a reference bottle filled with water, a temperature sensor, an alarm programmed to sound 30 seconds after the temperature sensor meets a pre-determined temperature, 69° C. melt-point paraffin wax in which a metal heat sink is placed to aid in heat distribution, a top plate, and a set of bags (heat transfer barriers) suspended from the top plate and positioned so that one side of the bag is in contact with the paraffin wax, and the other side open to accept a bottle placed therein. In preferred embodiments, the predetermined temperature is 73° C. In further embodiments, the plastic top plate comprises at least eight openings, with a transfer barrier disposed of within each opening, said transfer barrier having a generally cylindrical shape with an open top, with the sides and base of the cylinder in contact with the paraffin wax, wherein said cylinder defined by the transfer barrier suitable for connecting to, or being hung from the top plate, and thereafter accepting a bottle within the open top of the cylindrical shape.

A pasteurization device comprising an insulated heating tub, a metal heat sink, 69° C. melt-point paraffin wax, wherein the metal heat sink and the paraffin wax are combined inside the insulated heating tub; a temperature sensor connected to a microprocessor controlled device, suitable to measure temperature and to generate an alarm, a top plate of a material suitable to cover the wax; wherein the top plate comprises a plurality of openings corresponding to a concave space in the copper mesh mold of suitable size to accept a baby bottle; wherein the insulated heating tub can be heated to at least 73° C. and wherein the microprocessor controlled device provides an audible tone upon the temperature sensor reading 73° C. for at least 30 seconds.

A pasteurization device comprising an insulated heating element, a reference bottle filled with water, a temperature sensor, an alarm programmed to sound 30 seconds after the temperature sensor meets a pre-determined temperature, 69° C. melt-point paraffin wax in which a heat sink is placed to aid in heat distribution, a plastic top plate, a lid, and a set of bags suspended from the top plate and positioned so that one side of the bag is in contact with the paraffin wax, and the other side open to accept a bottle placed therein.

A pasteurization device comprising an insulated heating tub, a metal grid heat sink, 69° C. melt-point paraffin wax, wherein the metal grid heat sink and the paraffin wax are combined inside the insulated heating tub in regularly spaced grid within the insulated heating tub; a temperature sensor connected to a microprocessor controlled device, suitable to measure temperature and to generate an alarm, a top plate, a lid, and a material suitable to provide a barrier between the wax and a bottle placed within the barrier; wherein the top plate comprises a plurality of openings corresponding to a space in the metal grid heat sink of suitable size to accept a baby bottle; wherein the insulated heating tub can be heated to at least 80° C. and wherein the microprocessor controlled device provides an audible tone upon the temperature sensor reading 72.5° C. for at least 30 seconds. The device further preferably comprises a reference container filled with water; wherein the temperature sensor is positioned within the reference container and the temperature sensor reading is determined based upon the temperature of the reference container. Furthermore, the pasteurization device of claim 1, wherein the metal grid is regularly spaced within the insulated heating tub.

A pasteurization device comprising an electronically controlled heating device within a heating reservoir; a volume of 69° C. melt-point paraffin wax, sufficient to fill a portion of the heating reservoir; a heat sink defined within the heating reservoir with openings at a top portion of the heat sink of sufficient size to accept a container, a lid, a user interface device connected to the electronically controlled heating device having an attached temperature sensor capable of detecting temperature and, said user interface device capable of controlling the electronically controlled heating device. The device further comprising at least one heat transfer barrier having an inside wall, a bottom, an outside wall, and a top opening, said heat transfer barrier being disposed of within an opening at a top portion of the heat sink, said heat transfer barrier outside wall being in contact with the paraffin wax within the heating reservoir, being pliable to the pressure of wax surrounding said heat transfer barrier on the outer wall.

A method of pasteurizing breast milk using a heat transfer material of paraffin wax comprising: (a) heating a volume of 69° C. melt-point paraffin wax within a heating device to 75° C., said heating device comprising an electronically controlled heating device within a heating reservoir; a volume of 69° C. melt-point paraffin wax, sufficient to fill a portion of the heating reservoir; a heat sink defined within the heating reservoir with openings at a top portion of the heat sink of sufficient size to accept a container, a heat transfer barrier positioned within the openings at the top of the heat sink defined to create a first and second bottle opening, a user interface device connected to the electronically controlled heating device having an attached temperature sensor capable of detecting temperature and, said user interface device capable of controlling the electronically controlled heating device; (b) inserting a bottle of breast milk into a first bottle opening of a heating device, (c) placing said temperature sensor into a reference bottle, said reference bottle filled with a reference fluid of water; (d) placing said reference bottle into said second bottle opening; (e) heating the electronically controlled heating device by turning on the heating device; (f) heating the paraffin wax above 75° C. degrees Celsius; (g) starting a thirty-second timer on the user interface once the temperature sensor reaches 72.5 degrees Celsius; (h) generating an alarm after the thirty-second timer has elapsed; and (i) turning off the electronically controlled heating device.

### BRIEF DESCRIPTION OF THE DRAWINGS

FIG. 1 depicts an embodiment of the invention having a heating element base, wax disposed in said heating element base and metal heat sink disposed of in the wax in an exploded view.

FIG. 2 depicts a further exploded view of a pasteurization device, as well as a top plan view.

FIG. 3 depicts a profile view of components of a pasteurization device.

FIG. 4 depicts certain components of a pasteurization device.

FIG. 5 depicts a controller connected to a pasteurization device.

FIG. 6 depicts a controller and components related to pasteurization of fluids within a pasteurization device.

FIG. 7 depicts a pasteurization device and temperature sensor in a reference bottle.

FIGS. 8A-8D depict details of components of an embodiment of a pasteurization device.

FIGS. 9A-9D depict an embodiment of a heat sink component of a pasteurization device.

### DETAILED DESCRIPTION OF THE EMBODIMENTS

The device is a small-scale pasteurizer to allow for quick and easy HTST pasteurization of expressed breast milk. In a typical HTST pasteurization process, expensive machines and/or pressures are required, and thus in many cases, LTLT is utilized. However, HTST is frequently cited as leaving a superior product, though lower protein denaturization, as compared to LTLT. Herein, is defined a device that is particular suited for HTST, though it may be implemented with a LTLT protocol. Indeed, this feature of being capable of both HTST and LTLT is unique in such a low cost and simple device. The device is particularly suited for use in areas without refrigeration, as pasteurization may be used to extend the shelf life of expressed breast milk at room temperature if a lactating mother wishes to express and store milk to later feed to her child.

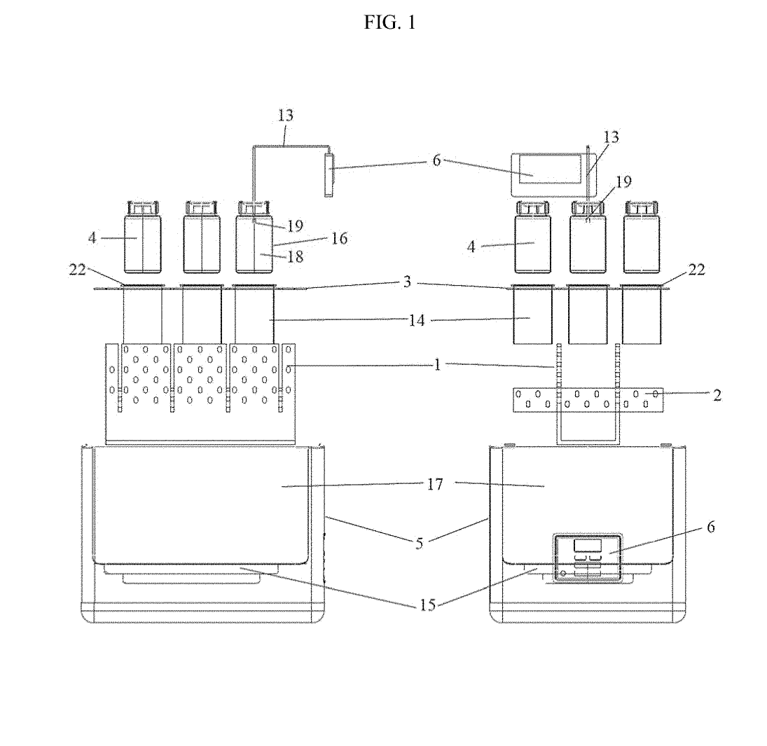

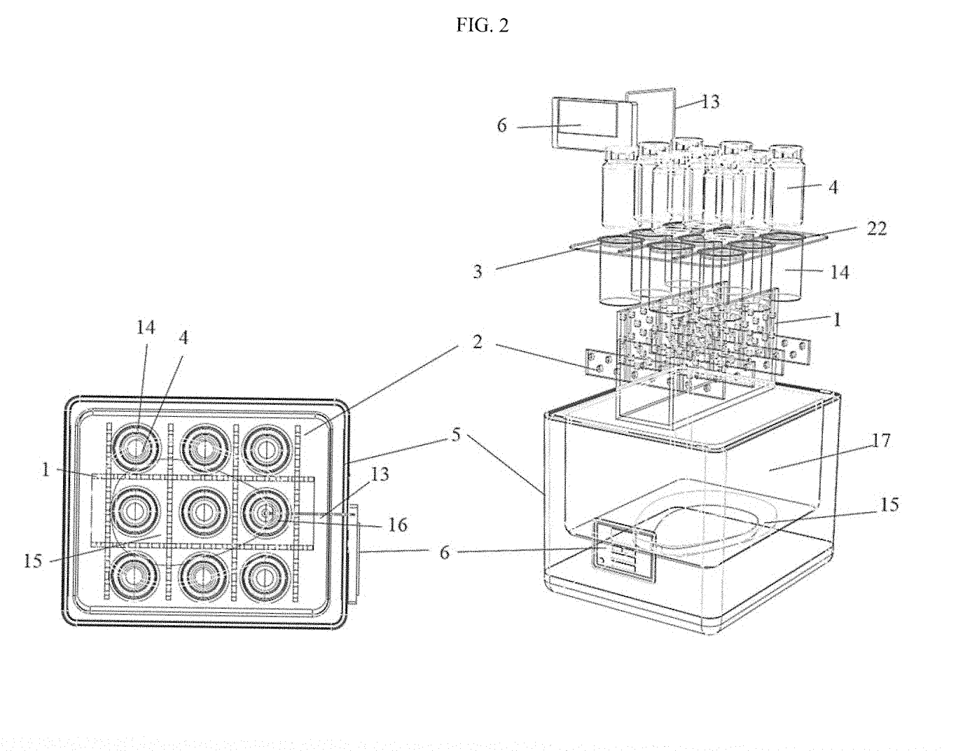

In the broadest sense, as depicted in FIGS. 1 and 2, the pasteurization device comprises an insulated heating reservoir 5. For example, a commercial or laboratory-grade water bath or sous-vide machine, as known in the art, can be utilized. The insulated heating reservoir 5 contains a tub or reservoir 21 placed on top of and/or adjacent to an underlying heating element 15. The heating element 15 is capable of rapidly raising the temperature of the material placed into the tub. In a typical scenario of the prior art, water is placed into the tub. However, water evaporates quickly when heated, and leaves residue with the device including minerals with the water, but also pathogens. Water is easily contaminated with bacteria or other virulent microorganisms and warm water provides for a highly efficient space for growth of such bacterial or microorganisms. Though water is the heating medium of choice for most pasteurizers, given the risk of bacterial colonization, and need for constant replacement due to evaporation, it was deemed to not be the ideal heat exchange medium for use in the device. This is especially true where clean water is difficult to obtain, thus increasing the risk of microorganisms or bacteria being present in the bath water.

Instead of water, high melt-point paraffin wax 17 is utilized as the heat exchange medium. Accordingly, wax, as depicted in both FIG. 1 and FIG. 2 is placed within the tub 21. After heating, paraffin wax 17 retains heat, but also resists rapid temperature changes. Thus, when a bottle containing unpasteurized milk (or other liquid) is placed in the device, the paraffin wax is able to maintain a relatively stable temperature (i.e. does not result in as diminished a temperature gradient as water would). Furthermore, as compared to water, paraffin wax naturally inhibits microorganism growth, limiting their presence in the heat exchange medium.

Paraffin wax holds heat effectively, but is also a good insulator. Accordingly, if the paraffin wax is simply placed into the tub 21 portion of the reservoir 5 by itself, there will be hot spots and cool spots in the wax. This ultimately means that undue time and energy will be needed to get all the material to a pre-determined temperature. Aluminum or copper is highly conductive, and so heats up quickly. Therefore, to ensure an even distribution of heat into the wax, a metal grid (heat sink) is distributed throughout the wax in the tub. For example, FIG. 1 depicts a metal frame having vertical supports 1 and horizontal supports 2, making up a grid like structure within the heat transfer material 17.

In certain embodiments, the metal grid is distributed evenly throughout the paraffin wax. However, in other embodiments, a metal mesh, being sufficiently malleable to form the wire into shapes to form shapes or molds in the paraffin wax situated within the tub. For example, the shapes and openings can be clearly seen in the exploded view in FIG. 2. Therefore, creating a shape or mold allows the grid to form certain indentations in the paraffin wax, like a cylindrical cup holder, such that a baby bottle could be placed into the concave mold and wire and wax would be around and underneath the bottle.

In certain embodiments, the aluminum grid may be exchanged with another suitable material that allows for improvement of heat distribution through the wax material. This includes but is not limited to: copper, iron, steel and other alloys, tungsten, tin, brass, and nickel.

The metal grid, in certain embodiments is placed within the wax material, but it does not necessarily need to be in contact with the base of the tub or the heating element. In other embodiments, the metal grid 1 and 2, can be directly in contact with the base of the tub, so as to directly heat the metal grid, or the metal grid can be connected directly to the heating element 15.

Unlike water that is typically used in a water bath, paraffin wax is highly adherent. It must therefore be separated from any material (such as the bottles whose content is being pasteurized) that should not be coated in paraffin wax. In order to separate the paraffin wax from the bottles, they are placed in a heat transfer barrier 14, which creates a recess 22, for placing a bottle 4. This heat transfer barrier allows for the heat to pass through the barrier 14, but maintains an open space for placement of a bottle. For example, silicone-coated rip-stop nylon fabric bags, or Teflon sleeves can be suspended from the top plate 3 into the wax 17. Bottles 4 to be pasteurized are placed directly into the nylon bags 14. The bags 14 act as an effective barrier to the paraffin wax but minimally impede heat transfer to the bottle. The heat transfer barrier 14 can also be molded into a cylindrical shape, having an enclosed bottom and sides, and an open top, thereby defining a cavity which is capable of accepting a bottle. The open top may further comprise a ring, lip, or flange that is wider than the openings of the top plate. Accordingly, the heat transfer barrier 14 can slide into the openings of the top plate, but be held by the lip. Other suitable attachment means or strategies can be employed as known to one of ordinary skill in the art. The end result is a barrier between the wax, that provides a cavity for accepting a bottle.

Alternative materials can be utilized for the heat transfer barrier 14 to separate the paraffin wax, including metals or plastics, polymers, or other suitable materials known to one of ordinary skill in the art. Certain embodiments may utilize preformed cups or molds that are connected to another material, e.g. nylon, so as to seal off the paraffin, but also to create molds/receptacles for placing a bottle. These molds may be of various sizes to fit bottles of different sizes, where appropriate. A controller 6, is further provided, having therein a processor, memory, suitable storage, a power source, controllable switches, and running, therein, a program able to activate one or more switches or components. For example, controlling the power to the heating element 15, as well as controlling a timer, which each can be activated by inputs from a timer or from a temperature probe 19.

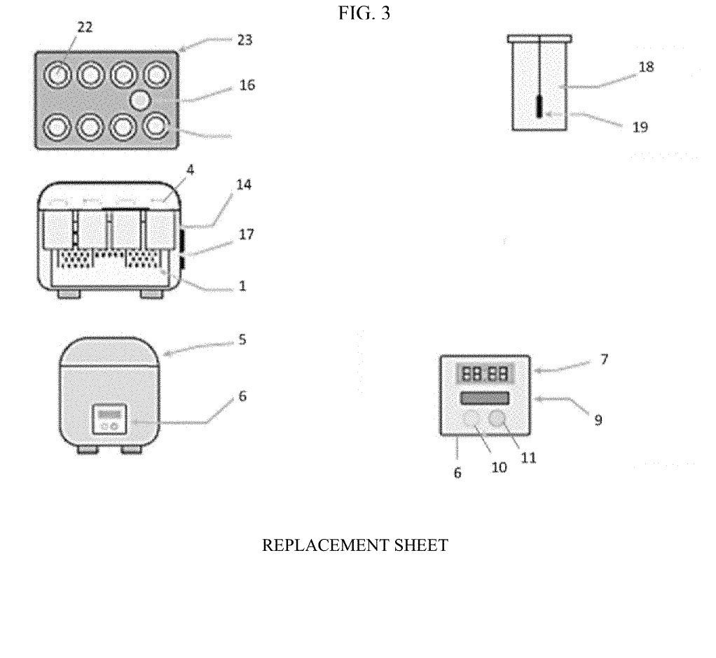

FIG. 3 provides a further view of several of the components that are utilized for a pasteurization device. The device comprises a heating device and reservoir 5, with a user interface 6 that controls a program suitable for detecting temperature through a temperature probe 19. The temperature probe is in a glass reference bottle 16, containing a reference liquid 18, typically water. The heating device 5 comprises a heated reservoir including a heating element 15, and metal grid composed of a heat sink base 1 and heat sink cross bars 2. A top plate 3 is further provided with openings 22 for a temperature barrier 14, which provides a recess for accepting one or more bottles. The heating device and reservoir 5 is filled with a heat transfer material 17, for example paraffin wax. To maintain the wax in the reservoir 21 and prevent contact with a bottle being heated, a heat transfer barrier 14 is provided defining a recess for accepting a bottle. A lid, 23 is optionally provided. Indeed, in certain embodiments, the top plate 3 may be sufficient to form the bottle openings 22, and to have the bottles open to ambient air. In other embodiments, it is necessary to enclose the heating bottles with a lid 23.

The user interface, as depicted in FIG. 3 is a simple device having a timer 7, a function button 9, and timer setting 10 and temperature setting 11 buttons. Additional user interfaces may include more buttons or displays, however the user interface exists to program the device and control the operation and necessary parameters for pasteurization.

To pasteurize milk, it needs to be heated to a sufficient temperature for pasteurization to occur. However, it may be difficult to determine when that temperature has been reached. Accordingly, to measure and control the temperature, a reference bottle 16 filled with a reference liquid 18, typically water, is placed into one of the mold openings. In FIG. 3, a centralized opening is provided by reference bottle 16. The heating curve of water is quite close to that of breast milk, for purposes of meeting a reference temperature, and so provides a close estimate for the temperature of the breast milk. A temperature probe 19 inserted into the reference bottle is attached to a temperature control module 6 and connected to a timer and an alarm 20. A simple programmable system on a platform such as Arduino or Raspberry Pi can be utilized to measure the temperature, count down a predetermined time at that temperature and then ring the alarm to indicate that the temperature and time has been met. These controllable systems can run appropriate software to perform the necessary tasks to heat the heating element 15, detect a temperature, create a timer, start and stop a timer which can be depicted on a display, as well as generate an alarm or notification. Other suitable programmable platforms can be utilized as is known to those of ordinary skill in the art.

The breast milk is heated to and held at 73° C. for 15 seconds. This HTST method of pasteurization effectively reduces the bacterial content of the milk. The nutritional content of the milk is minimally affected and infants can safely consume the pasteurized product after a storage time of 8-10 hours at tropical ambient temperature (40° C.). Once 73° C. is reached, the microprocessor control system counts down 15 seconds at that temperature before sounding the alarm. After the alarm has indicated, the milk has been safely pasteurized and should be removed from the device to prevent further degradation. In certain embodiments, the control system counts down 15, 20, 25, or 30 seconds before sounding an alarm. Longer times are unnecessary as the milk is already safely pasteurized, and thus only serves to degrade the milk proteins.

At this point, the system can be turned off, or automatically turns off, and the milk can be removed from the device to cool to room temperature. The pasteurization process allows the milk to then be consumed safely by the infant within 8-10 hours after pasteurization, assuming storage at tropical ambient room temperature (35° C.-40° C.).

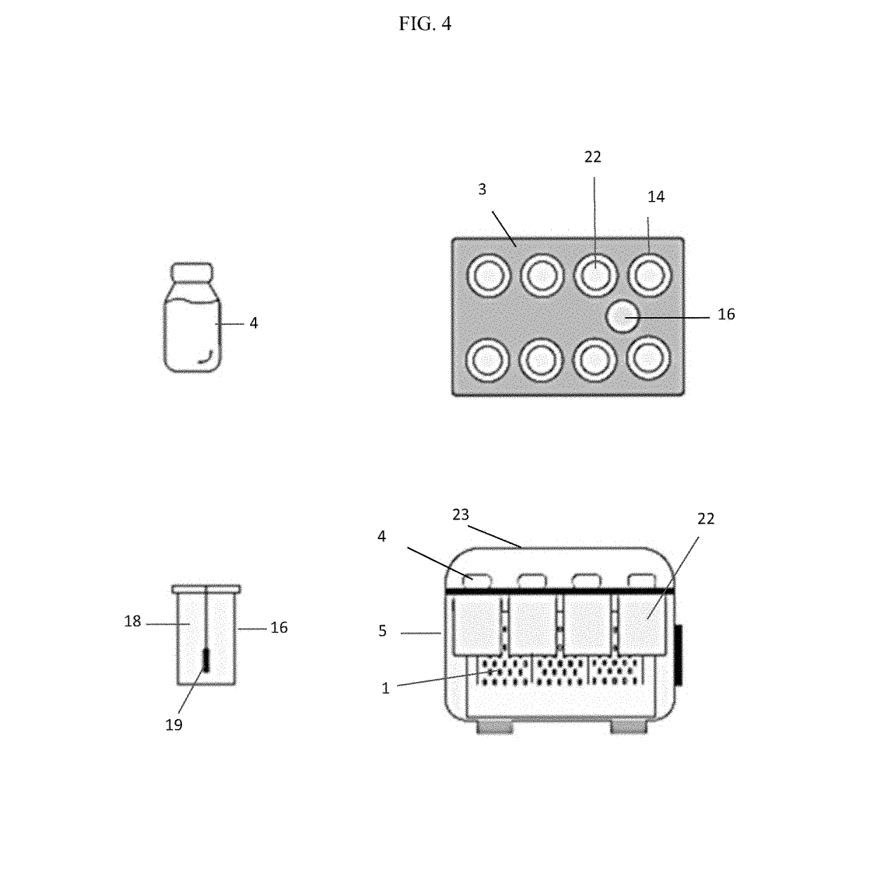

FIGS. 4-7 provide a step-by-step process for pasteurization, including reference to the device as described herein. The device is first powered on, wherein the heating element 15 is activated to heat the wax 17. The wax will turn from a solid to a liquid at a temperature of about 69 C, and this phase change can be visualized easily through a slight color change, as well as simply solid to liquid. Furthermore, a reference bottle and temperature probe may be inserted into a bottle opening 22, to identify 72 C being reached. Once the wax 17 is at temperature, we can begin the process of HTST.

FIG. 4 details a sterilized bottle 4, which is placed into a bottle opening 22. A reference bottle 16 is placed central to the device. A top plate 3 is provided to give support to the device and support the bottle openings 22, having therein a heat transfer barrier 14. At least one bottle 4, is placed into a bottle opening 22, and a temperature sensor 19 is placed into a reference liquid 18 within the reference bottle 16, and connected to the controller with a sensor cord 13. FIG. 4 depicts that the lid 23 that may be placed over the unit and the milk is ready to begin the pasteurization process.

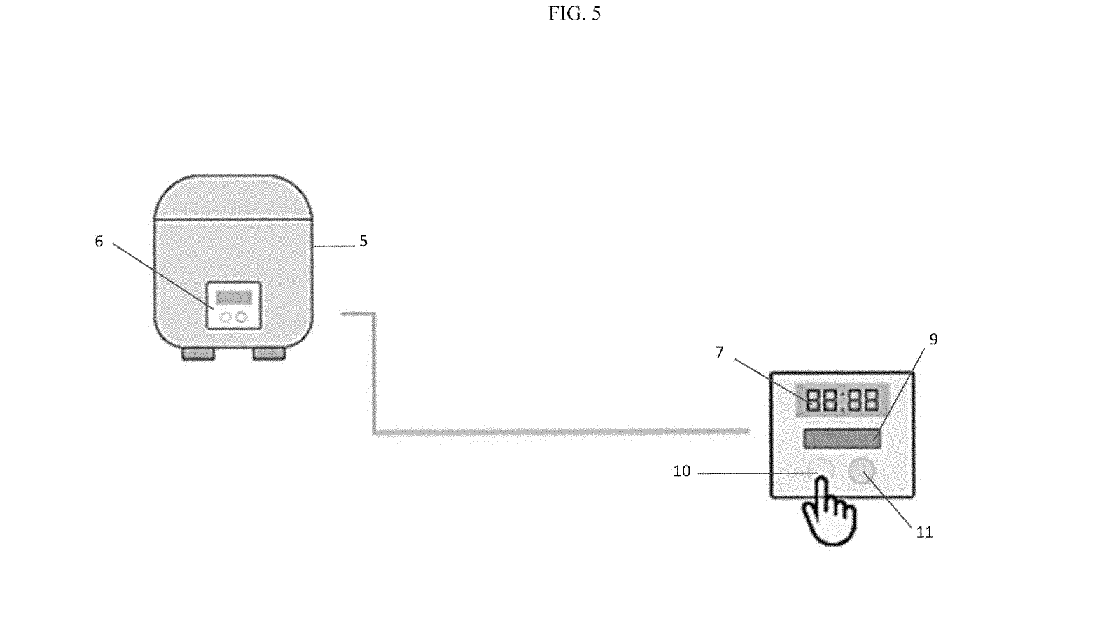

FIG. 5 depicts that a user presses a button, shown are the start timer 9, the temperature set 11 and the on/off button 8. This displays a timer 7 on the LCD screen. This timer is set at 30 seconds, which counts down, once the reference temperature sensor reaches 72.5 C. To begin the HTST process, the user presses button 9 to begin the process. This engages to the heating element 15 within the heating device 5 and begins to heat the heat transfer material 17, though it is already at 72.5 C. Indeed, the device can stay at a stable temperature, through the heating element 15 simply being held at 72.5 C. For pasteurization, then, the heating element 15, can be increased above 72.5 C, for example to 73 C or 75 C, or higher, to ensure fast pasteurization.

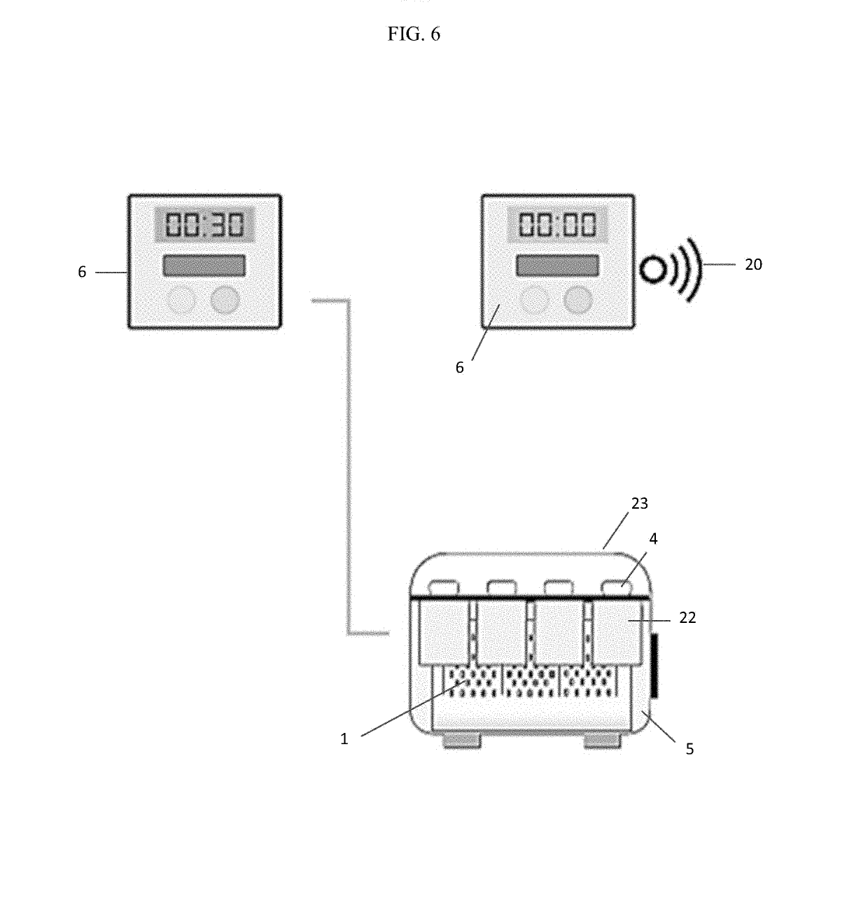

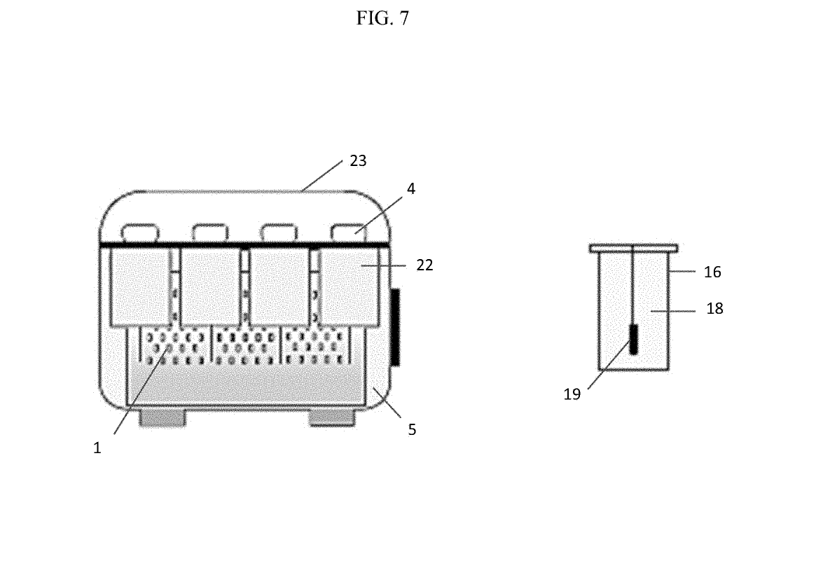

FIGS. 6 and 7 depict the temperature sensor 19 within a reference liquid 18, inside of a reference bottle 16. Once the temperature sensor 19 detects a temperature of 72.5 Celsius, the controller 6, begins a 30 second timer. At this point, the heating element 15 maintains the temperature for that 30 seconds. Upon the expiration of the 30 seconds, an alarm 20 from the control panel 6 is generated. This alarm can be visual, audible, text, provide an electronic notice, or other form of communication, to identify that the timer has completed. At the same time, the expiration of the timer will indicate to the system to power down the heating element 15, effectively turning the device into standby mode. A user can then remove the bottle 4 from the unit and the milk within the device is now safely pasteurized.

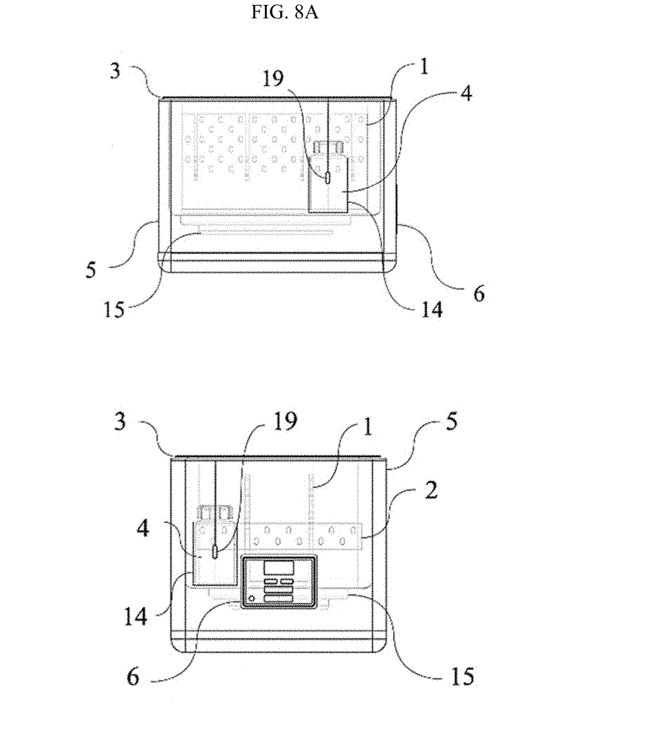

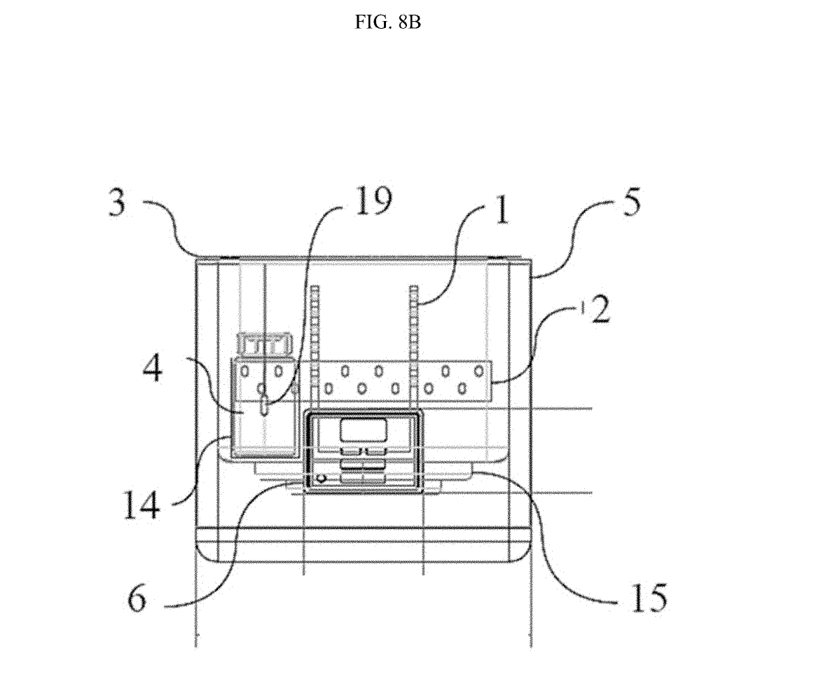

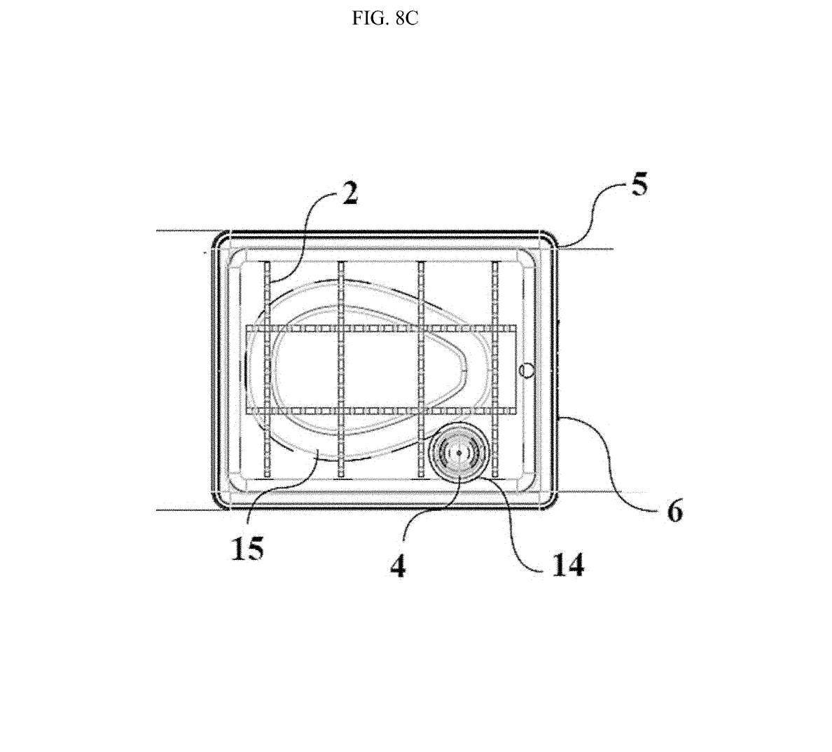

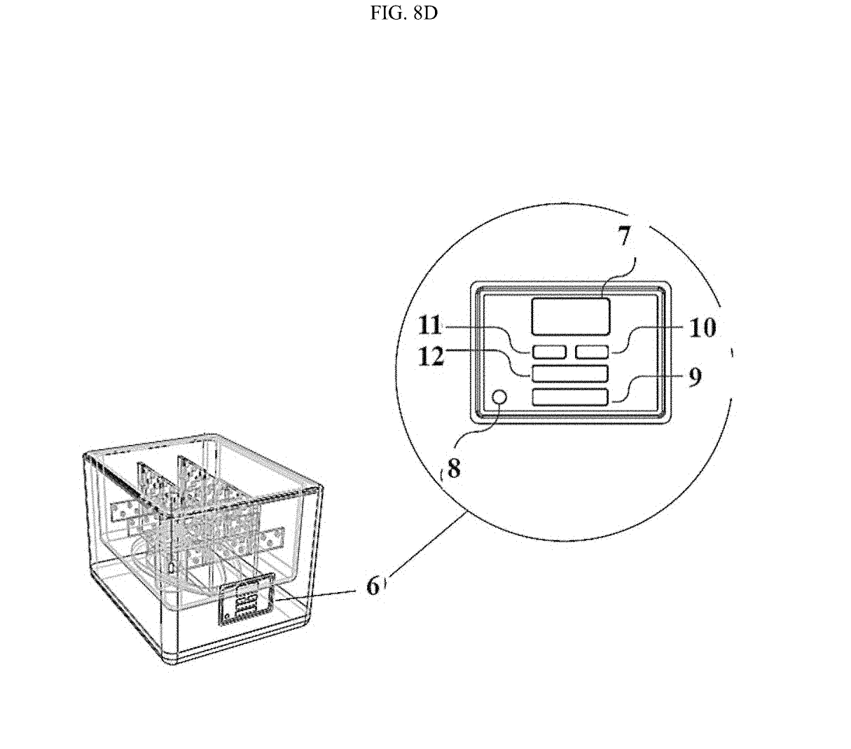

FIG. 8 provides a further detail of a further embodiment of a pasteurization device. A top plan view is shown of the device, depicting a heat sink base 1 and a horizontal heat sink cross bars 2, which together provide for a heat sink component. A heating element 15 is placed in or is a part of the bottom of a heating device/reservoir, 5, and a bottle opening 22 is provided having a heat transfer barrier 14 to separate the heat transfer material 17 from the opening 22, which is able to accept a bottle 4.

FIGS. 8A-8D further depicts components of the device. FIGS. 8A and 8B depict a side profile view. The user interface 6, also referred to as a control panel, is depicted as mounted to the external side of the heating device 5. Internally, the heating element 15 is shown as well as the heat sink base 1 and the cross bars 2, with a reference bottle 16 filled with reference liquid 18 and a temperature probe 19 being shown inside the device. The control panel 6 comprises a LED display 7, an on/off or power button 8, a start button 9, a set timer button 10, a set temperature button 11, and a temperature increase/decrease button 12. Those of skill in the art will recognize that these buttons can be contained within a single menu or file system within a controllable user interface, and thus these are shown merely as examples of a particular set of buttons for functionality. The interface 6 is used to control the heating element 15, by powering the device upon need, which heats the heating element 15, and to measure temperature using the attached temperature sensor 19. By use of the temperature sensor 19, the interface 6 can identify when a pre-determined temperature is reached, maintain said temperature, and then provide an alarm to notify a user that the pasteurization process is complete. At the same time, the interface 6 can properly heat or turn off the heating element 15 as necessary to perform the procedure.

FIG. 8C depicts a top plan view, indicating the organization of the heat sink 1 and 2, within the body of the device, as well as the position of the temperature barrier 14, within a section of the heat sink.

FIG. 8D details a front perspective view, with the internal components shown through, and a blow up of the interface 6 detail.

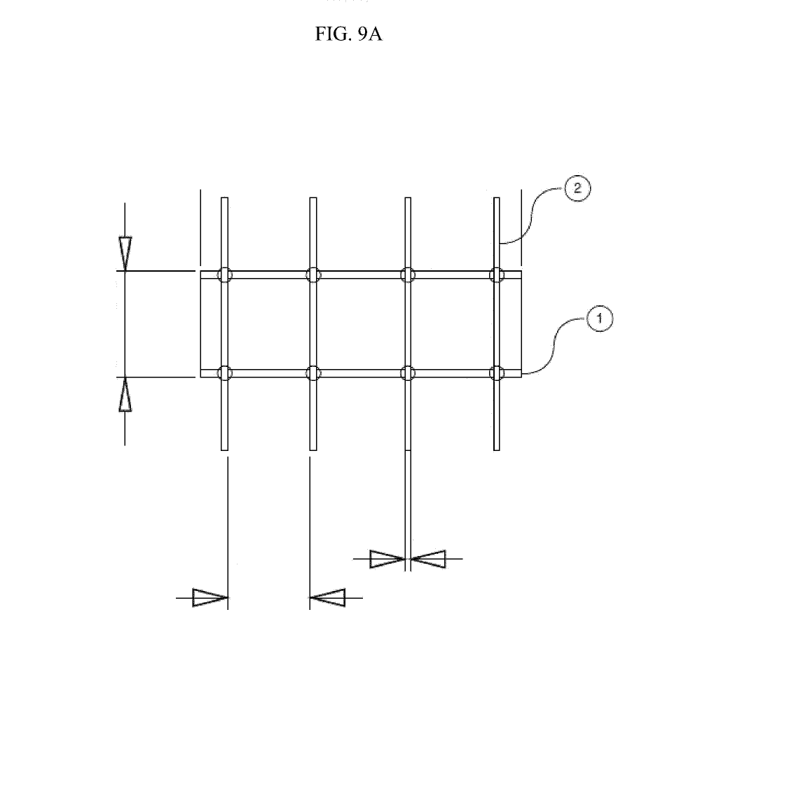

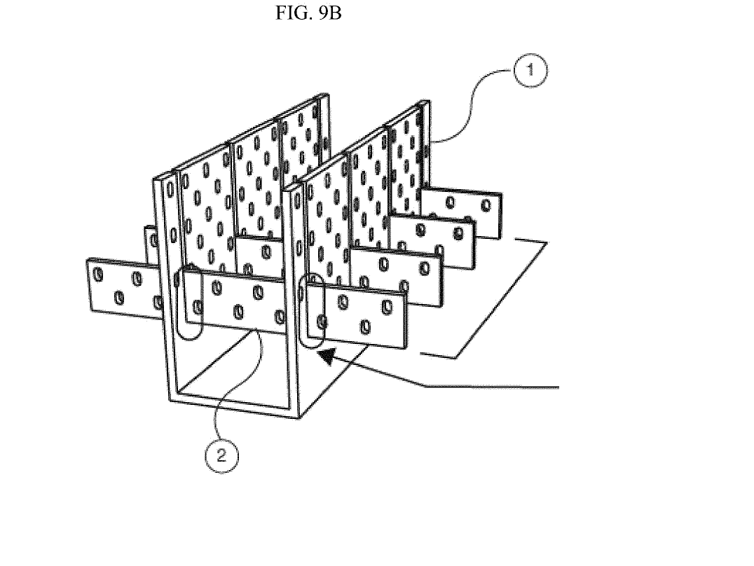

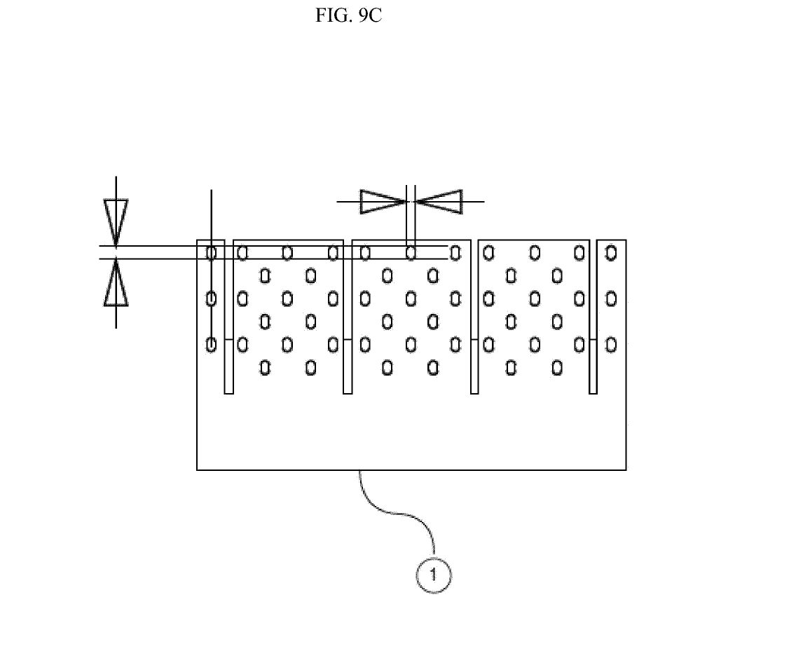

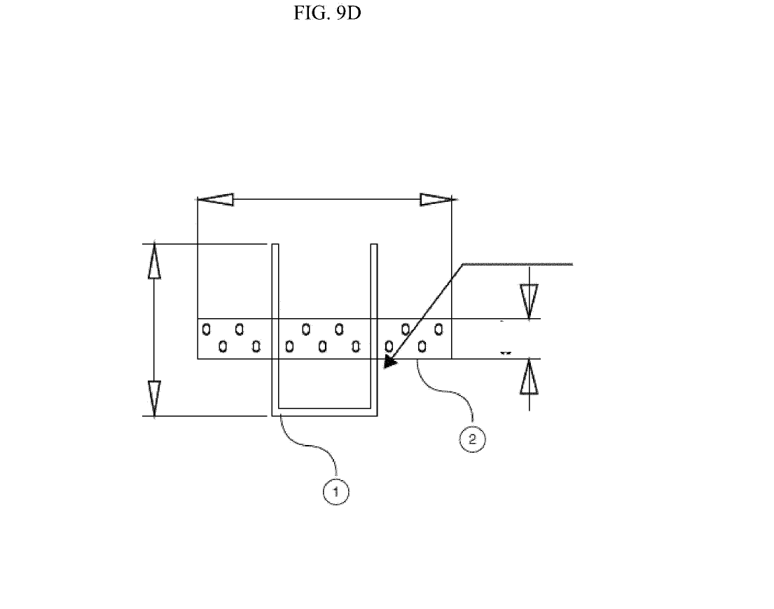

FIGS. 9A-D details a particular embodiment of the heat sink frame, including a heat sink base 1 and a set of heat sink cross bars 2. These bars create a lattice like structure, which is then surrounded by a heat transfer material 17, e.g. paraffin wax. Additional supports, in the X, Y, and Z directions, within the reservoir 21 may be included to increase the amount of heat sinks within the heat transfer material 17, so as to increase the heating rate or the efficiency and consistency of the material to heat. FIG. 9A details a top plan view. FIG. 9B details a side perspective view, and detail of an embodiment having holes in the heat sink. FIG. 9C depicts a plan view of a heat sink base 1, and FIG. 9D depicts a side view of the base 1 and the horizontal supports 2 of the heat sink.

Testing Examples were performed on the device as follows:

Test 1—Time it takes for wax to turn from solid (22 C) to a liquid (72.5 C)

Process:

1. Set machine to temperature (72.5 C)

2. Insert thermocouple within a reference bottle

3. Start timer

4. Take Photos and temperature readings every 10 min.

5. Once liquid hold temperature for 5 minutes.

Results:

Test A—9.7 L—wax

SV starting temp: 26 C

Wax movement @25 min

SV reached 72.5 C@42 min—stayed at this temp for 30 min

@1 hour all wax melted but corners

1 hour 5 min to full melt of all wax within the device.

Test B—9.7 L—wax

SV Starting temp: 32 C

SV reached 72.5 C@38 min

1 Hour 2 min to full melt

Test C—6.9 L—wax

SV Starting temp: 35 C

SV reached 72.5 C@28 min.

40 min to full melt

Heat distribution Results:

From the time-lapse videos and images we were able to clearly see where the wax was melting from first and how the heat sink was working.

The center heated up first around the aluminum rails. The heat moved from the base element of the machine up the through the heat sink and melted all the wax in contact with it first. The heat then radiated out from the center and made its way to the outside and to the corners last. Using a greater number of heat sinks will increase speed of melting the wax. Accordingly, we have preferably used a heat sink having a grid pattern of about 3″×3″, with 2″×2″ or 1″×1″ also suitable. The differences in weight can be negligible using lightweight materials for the heat sink.

Test 2.1

Time it takes for milk to pasteurize (testing location of 1 bottle)

Outline: Once wax has fully melted, bottle(s) will be placed in a heat transfer barrier, with the wax surrounding just below the neck of the bottle. Thermocouple (temperature sensor 19) will be placed inside the bottle to measure temp and time it takes to reach desired temp.

Process:
1. Place the thermocouple inside the bottle
2. Record temp of starting milk temperature
3. Place in side of a Teflon sleeve or a nylon bag and then place bottles in liquid paraffin wax (at stable temp of 72.5). The Teflon sleeve has more rigidity than the nylon bag. The nylon bag allows for the wax to surround the bottle, while the Teflon sleeve gives some slight space between the bottle and the wax.
4. Start timer
5. Record time once internal temperature has reached 72.5 for 15 seconds

Results:

Test A—no lid

Wax starting temperature—75 C

Milk starting temperature—22.1 C

Time it took for pasteurization—1 hour 25 seconds

| Wax start temp | Milk start temp | Changes | Time |
|---|---|---|---|
| 75 C. | 22.1 | No lid, Teflon | 1 hr. 25 sec |
| 75 C. | 22.1 | Lid, Teflon | 25 min, 35 sec |
| 72.5 | 22.1 | Lid, Teflon | 26 min 45 sec. |
| 72.5 | 22.1 | Lid, nylon bag | 18 min 41 sec. |

The results indicate that a lid is helpful in increasing the speed of pasteurization. Accordingly, preferred use includes a lid to heat the milk. Furthermore, it is useful to have the wax in as direct contact as possible to the bottle to transfer heat. Accordingly, use of a bag or other heat transfer barrier 14 that allows for the wax to fill around the bottle, on the outside of the barrier 14 will increase heating efficiency.

Results: In the next round of testing we should spike the wax temperature—increase the heat to greater than 75 C, so the optimal bottle temperature is reached faster.

Test B

Same as the test above, with temperature of wax at 80 C

| Wax start temp | Milk start temp | Changes | Time |
|---|---|---|---|
| 80 C. | 22.1 C. | No lid, Teflon | 51 min, 22 sec. |
| 80 C. | 22.1 C. | Lid, Teflon | 22 min, 18 sec. |
| 80 C. | 22.1 C. | Lid, nylon bag | 15 min 11 sec. |

Additional tests were performed using a nylon bag and a volume of between 6 and 8 ounces of milk in a bottle, using a glass bottle, and resulted in times of about 12-20 minutes at a temperature of 78 C. Accordingly, a preferred embodiment uses a temperature above 72.5 C, a lid, and a heat transfer barrier that is snug around the bottle, to allow for no dead space between the bottle and the wax. Volumes of milk between 4 and 12 ounces are the preferable volume for pasteurization in a single bottle—even fluid volumes, if more than one bottle is being done simultaneously, is preferred.

What is claimed is:

1. A pasteurization device comprising an insulated heating tub, a metal grid heat sink, 69° C. melt-point paraffin wax, wherein the metal grid heat sink and the paraffin wax are combined inside the insulated heating tub in regularly spaced grid within the insulated heating tub; a temperature sensor connected to a microprocessor controlled device, suitable to measure temperature and to generate an alarm, a top plate, a lid, and a material suitable to provide a barrier between the wax and a bottle placed within the barrier; wherein the top plate comprises a plurality of openings corresponding to a space in the metal grid heat sink of suitable size to accept a baby bottle; wherein the insulated heating tub can be heated to at least 80° C. and wherein the microprocessor controlled device provides an audible tone upon the temperature sensor reading 72.5° C. for at least 30 seconds.

2. The pasteurization device of claim 1 further comprising a reference container filled with water; wherein the temperature sensor is positioned within the reference container and the temperature sensor reading is determined based upon the temperature of the reference container.

3. The pasteurization device of claim 1, wherein the top plate comprises at least eight openings, and wherein each opening corresponds to a recess suitable to accept a bottle.

4. The pasteurization device of claim 1, wherein the metal grid is regularly spaced within the insulated heating tub.

5. The pasteurization device of claim 1, wherein the metal grid is spaced at 3″ by 3″ or less.

6. The pasteurization device of claim 1, wherein the material suitable to provide a barrier between the wax and a bottle placed therein is selected from nylon, Teflon coated fabric, silicone coated fabric, or combinations thereof.

7. The pasteurization device of claim 6, wherein the material is formed in a cylindrical shape having a bottom, sides, and an open top, and defining a lip around the open top suitable to engage with the top plate.

8. A pasteurization device comprising an electronically controlled heating device within a heating reservoir; a volume of 69° C. melt-point paraffin wax, sufficient to fill a portion of the heating reservoir; a heat sink defined within the heating reservoir with openings at a top portion of the heat sink of sufficient size to accept a container, a lid, a user interface device connected to the electronically controlled heating device having an attached temperature sensor capable of detecting temperature and, said user interface device capable of controlling the electronically controlled heating device.

9. The pasteurization device of claim 8 further comprising at least one heat transfer barrier having an inside wall, a bottom, an outside wall, and a top opening, said heat transfer barrier being disposed of within an opening at a top portion of the heat sink, said heat transfer barrier outside wall being in contact with the paraffin wax within the heating reservoir, being pliable to the pressure of wax surrounding said heat transfer barrier on the outer wall.

10. The pasteurization device of claim 9 comprising a reference bottle placed within a heat transfer barrier.

11. The pasteurization device of claim 10, comprising a reference liquid placed within the reference bottle, and said temperature sensor placed within the reference liquid.

12. The pasteurization device of claim 8 wherein the user interface comprises a display, a plurality of control buttons, and an alarm mechanism.

13. A method of pasteurizing breast milk using a heat transfer material of paraffin wax comprising:
(a) heating a volume of 69° C. melt-point paraffin wax within a heating device to 75° C., said heating device comprising an electronically controlled heating device within a heating reservoir; a volume of 69° C. melt-point paraffin wax, sufficient to fill a portion of the heating reservoir; a heat sink defined within the heating reservoir with openings at a top portion of the heat sink of sufficient size to accept a container, a heat transfer barrier positioned within the openings at the top of the heat sink defined to create a first and second bottle opening, a user interface device connected to the electronically controlled heating device having an attached temperature sensor capable of detecting temperature and, said user interface device capable of controlling the electronically controlled heating device;
(b) inserting a bottle of breast milk into a first bottle opening of a heating device,
(c) placing said temperature sensor into a reference bottle, said reference bottle filled with a reference fluid of water;
(d) placing said reference bottle into said second bottle opening;
(e) heating the electronically controlled heating device by turning on the heating device;
(f) heating the paraffin wax above 75° C. degrees Celsius;
(g) starting a thirty-second timer on the user interface once the temperature sensor reaches 72.5 degrees Celsius;
(h) generating an alarm after the thirty-second timer has elapsed; and
(i) turning off the electronically controlled heating device.
